(19) United States
(12) Patent Application Publication
(10) Pub. No.: US 2022/0049780 A1
(43) Pub. Date: Feb. 17, 2022

(54) MULTIFUNCTIONAL EXPANSION VALVE

(71) Applicants: Hyundai Motor Company, Seoul (KR); Kia Motors Corporation, Seoul (KR)

(72) Inventor: Yeonho Kim, Seoul (KR)

(73) Assignees: Hyundai Motor Company, Seoul (KR); Kia Motors Corporation, Seoul (KR)

(21) Appl. No.: 17/181,943

(22) Filed: Feb. 22, 2021

(30) Foreign Application Priority Data
Aug. 11, 2020 (KR) 10-2020-0100484

(51) Int. Cl. F16K 11/087; B60H 1/00; F16K 27/06; F25B 41/33

(52) U.S. Cl. CPC F16K 11/087; B60H 1/00485; F25B 2341/062; F25B 41/33; F16K 27/067

(57) ABSTRACT

A multifunctional expansion valve may include a second exit, and a chamber fluidically-communicating with the first entry, the second entry, the first exit, and the second exit, and a needle valve movably mounted in the chamber of the valve body along up and down directions, wherein the first entry and the first exit are selectively fluidically-communicated to each other and the second entry and the second exit are selectively fluidically-communicated to each other according to a position of the needle valve.

### CROSS-REFERENCE TO RELATED APPLICATION

The present application claims priority to Korean Patent Application No. 10-2020-0100484, the entire contents of which is incorporated herein for all purposes by this reference.

### BACKGROUND OF THE INVENTION

### Field of the Invention

The present invention relates to a multifunctional expansion valve. More particularly, the present invention relates to a multifunctional expansion valve in which the functions of an expansion valve and a bypass valve are integrated.

### Description of Related Art

An air conditioning system for a vehicle includes an air conditioning device circulating a refrigerant to heat or cool an interior of the vehicle.

The air conditioning device, which is to maintain the interior of the vehicle at an appropriate temperature regardless of a change in an external temperature to maintain a comfortable internal environment, is configured to heat or cool the interior of the vehicle through heat exchange by an evaporator in a process in which a refrigerant discharged by driving of a compressor is circulated to the compressor through a condenser, a receiver drier, an expansion valve, and the evaporator.

That is, the air conditioning device lowers a temperature and a humidity of the interior by condensing a high-temperature high-pressure gas-phase refrigerant compressed from the compressor by the condenser, passing the refrigerant through the receiver drier and the expansion valve, and then evaporating the refrigerant in the evaporator in a cooling mode in summer.

Recently, as interest in energy efficiency and an environmental contamination problem are increased day by day, there is a demand for developing an environmentally friendly vehicle which is configured for substantially replacing an internal combustion engine vehicle, and the environmentally friendly vehicle is commonly divided into an electric vehicle which is driven by use of a fuel cell or electricity as a power source and a hybrid vehicle which is driven by use of an engine and an electric battery.

In the electric vehicle or the hybrid vehicle among these environmentally friendly vehicles, a separate heater is not used, unlike an air conditioner of a general vehicle, and an air conditioner used in the environmentally friendly vehicle is known as a heat pump system.

Meanwhile, the electric vehicle generates driving force by converting chemical reaction energy between oxygen and hydrogen into electrical energy. In the present process, thermal energy is generated by a chemical reaction in a fuel cell. Therefore, it is necessary in securing performance of the fuel cell to effectively remove generated heat.

Furthermore, the hybrid vehicle generates driving force by driving a motor using electricity supplied from the fuel cell described above or an electrical battery, together with an engine operated by a general fuel. Therefore, heat generated from the fuel cell or the battery and the motor may be effectively removed to secure performance of the motor.

Therefore, in the hybrid vehicle or the electric vehicle according to the related art, a cooling device, a heat pump system, and a battery cooling system may be configured using separate closed circuits, respectively, to prevent heat generation in the motor, an electrical component, and the battery including the fuel cells.

Accordingly, size and weight of a cooling module disposed at the front of the vehicle are increased, and a layout of connection pipes supplying a coolant or a refrigerant to each of the heat pump system, the cooling device, and the battery cooling system in an engine compartment becomes complicated.

Furthermore, since the battery cooling system heating or cooling the battery depending on a state of the vehicle is separately provided so that the battery exhibits optimal performance, a plurality of valves for connecting the respective connection pipes to each other are used, increasing manufacturing cost of the vehicle.

Meanwhile, there is a case that the refrigerant does not pass through the evaporator and bypass the expansion valve during an operation of the heat pump system. Conventionally, in the instant case, the refrigerant bypasses the evaporator through an additional bypass valve.

However, in the case of applying the additional bypass valve from the expansion valve, the layout becomes complicated as the number of valves increases, and the manufacturing cost of the vehicle increases.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a multifunctional expansion valve in which a function of a bypass valve is added to an expansion valve.

A multifunctional expansion valve according to various exemplary embodiments of the present invention may include a second exit, and a chamber fluidically-communicating with the first entry, the second entry, the first exit, and the second exit, and a needle valve movably disposed in the chamber of the valve body along up and down directions, wherein the first entry and the first exit are selectively fluidically-communicated to each other and the second entry and the second exit are selectively fluidically-communicated to each other according to a position of the needle valve.

The chamber may include a first chamber connected to the first entry and the first exit, and a second chamber connected to the second entry, positioned below the first chamber, and have large diameter comparing to the first chamber, wherein the valve body includes a valve inclined portion formed in a boundary between the second chamber and the second exit.

The needle valve may include a needle body; a needle enlargement portion corresponding to the dimeter of the first chamber; a needle expansion portion formed below the needle enlargement portion and corresponding to a dimeter of the second exit; and a needle inclined portion formed in an end portion of the needle expansion portion.

The first entry and the first exit may be communicating with each other, and the second entry and the second exit may be blocked in first mode where the needle valve moves to a first position, the first entry and the first exit may be blocked, and the second entry and the second exit may be partially communicate with each other in a second mode where the needle valve moves to a second position, and the first entry and the first exit may be blocked, and the second entry and the second exit may be fully communicate with each other in a third mode where the needle valve moves to a third position thereof

In the first mode, the needle valve may move to a lowest position inside the chamber, the needle expansion portion of the needle valve may be fully inserted into the second exit, blocking the second entry and the second exit, and the first entry and the second exit may be communicate with each other through the first chamber.

In the second mode, the needle valve may move upward by a predetermined height from the lowest position inside the chamber, the needle enlargement portion of the needle valve may be fully inserted into the first chamber so that the first entry and the first exit are blocked, and the needle expansion portion of the needle valve may be partially inserted into the third chamber so that the second entry and the second exit partially communicate with each other.

The needle inclined portion and the valve inclined portion may be disposed to face each other, fluid flowing through the second entry may be expanded through a gap between the needle inclined portion of the needle valve and the valve inclined portion of the valve body.

In the third mode, the needle valve may move to a highest position inside the chamber, the needle enlargement portion of the needle valve may be fully inserted into the first chamber so that the first entry and the first exit are blocked, and the needle expansion portion of the needle valve may be fully separated from the third chamber so that the second entry and the second exit fully communicate with each other.

The multifunctional expansion valve according to various exemplary embodiments of the present invention may further include a main housing into which the valve body is accommodated, wherein the main housing is formed with a first inlet conduit communicating with the first entry, a second inlet conduit communicating with the second entry, a first outlet conduit communicating with the first exit, and a second outlet conduit communicating with the second exit; and a sealing member provided between the main housing and the valve body.

The multifunctional expansion valve according to various exemplary embodiments of the present invention may further include a separation wall extending toward an internal wall of the main housing from an external circumference of the valve body between the first entry and the second entry to separate a fluid flowing from the first entry and a fluid flowing from the second entry between the valve body and the main housing.

A multifunctional expansion valve according to various exemplary embodiments of the present invention may include a valve body including a first entry, a second entry, a first exit, a second exit, and a chamber fluidically-communicating with the first entry, the second entry, the first exit, and the second exit; and an auxiliary body provided in the chamber, and including a first connection conduit connected to the first entry, a second connection conduit connected to the first exit, and an auxiliary chamber communicate with the first connection conduit and the second connection conduit; and a needle valve movably disposed in the chamber of the valve body in a longitudinal direction of the chamber;, wherein the first entry and the first exit are selectively fluidically-communicated to each other and the second entry and the second exit are selectively fluidically-communicated to each other according to a position of the needle valve.

The chamber may include a first chamber provided with the auxiliary body; and a second chamber connected to the second entry and disposed below the first chamber, wherein a valve inclined portion may be formed in a boundary between the second chamber and the second exit.

The needle valve may include a needle body; a needle enlargement portion corresponding to an internal diameter of the auxiliary chamber; a needle expansion portion formed below the needle enlargement portion and corresponding to a diameter of the third chamber; and a needle inclined portion formed in an end portion of the needle expansion portion.

The first entry and the first exit may be communicating with each other, and the second entry and the second exit are blocked in a first mode where the needle valve moves to a first position, the first entry and the first exit may be blocked, and the second entry and the second exit may be partially communicate with each other in a second mode where the needle valve moves to a second position, and the first entry and the first exit may be blocked, and the second entry and the second exit may be fully communicate with each other in a third mode where the needle valve moves to a third position thereof.

In the first mode, the needle valve may move to a lowest position inside the chamber, the needle expansion portion of the needle valve may be fully inserted into the second exit, blocking the second entry and the second exit, and the first entry and the second exit may be communicate with each other through the first chamber.

In the second mode, the needle valve may move upward by a predetermined height from the lowest position inside the chamber, the needle enlargement portion of the needle valve may be fully inserted into the first chamber so that the first entry and the first exit are blocked, and the needle expansion portion of the needle valve may be partially inserted into the third chamber so that the second entry and the second exit partially communicate with each other.

The needle inclined portion and the valve inclined portion may be disposed to face each other, and fluid flowing through the second entry may be expanded through a gap between the needle inclined portion of the needle valve and the valve inclined portion of the valve body.

In the third mode, the needle valve may move to a highest position inside the chamber, the needle expansion portion of the needle valve may be fully inserted into the first chamber so that the first entry and the first exit are blocked, and the needle expansion portion of the needle valve may be fully separated from the third chamber so that the second entry and the second exit fully communicate with each other.

The multifunctional expansion valve according to various exemplary embodiments of the present invention may further include a main housing into which the valve body is accommodated, wherein the main housing is formed with a first inlet conduit communicating with the first entry, a second inlet conduit communicating with the second entry, a first outlet conduit communicating with the first exit, and a second outlet conduit communicating with the second exit; and a sealing member provided between the main housing and the valve body.

The multifunctional expansion valve according to various exemplary embodiments of the present invention may further include a separation wall extending toward an internal wall of the main housing from an external circumference of the valve body between the first entry and the second entry to separate a fluid flowing from the first entry and a fluid flowing from the second entry between the valve body and the main housing.

According to various exemplary embodiments of the present invention, it is possible to implement the multifunctional expansion valve with a bypass valve function added to an expansion valve of an air conditioning system.

Furthermore, since the function of the bypass valve to the expansion valve, overall structure of a heat pump system may be simplified, and manufacturing coast of a vehicle may be reduced.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view exemplarily illustrating a multifunctional expansion valve according to a first exemplary embodiment of the present invention.

FIG. 2 is a partially cut-away perspective view exemplarily illustrating a valve body according to a first exemplary embodiment of the present invention.

FIG. 3 is a partially cut-away perspective view exemplarily illustrating a main housing according to a first exemplary embodiment of the present invention.

FIG. 4 is a partially cut-away perspective view exemplarily illustrating a valve body according to a first exemplary embodiment of the present invention.

FIG. 5 is a perspective view exemplarily illustrating a needle valve according to a first exemplary embodiment of the present invention.

FIG. 6 is a side view exemplarily illustrating a needle valve according to a first exemplary embodiment of the present invention.

FIG. 7 is a drawing for explaining an operation of a multifunctional expansion valve in a first mode according to a first exemplary embodiment of the present invention.

FIG. 8 is a drawing for explaining an operation of a multifunctional expansion valve in a second mode according to a first exemplary embodiment of the present invention.

FIG. 9 is a drawing for explaining an operation of a multifunctional expansion valve in a third mode according to a first exemplary embodiment of the present invention.

FIG. 10 is a cross-sectional view exemplarily illustrating a multifunctional expansion valve according to a second exemplary embodiment of the present invention.

FIG. 11 is a partially cut-away perspective view exemplarily illustrating an auxiliary body according to a second exemplary embodiment of the present invention.

FIG. 12 is a cross-sectional view exemplarily illustrating a multifunctional expansion valve according to a third exemplary embodiment of the present invention.

FIG. 13 is a partially cut-away perspective view exemplarily illustrating an auxiliary body according to a third exemplary embodiment of the present invention.

FIG. 14 is a partially cut-away perspective view exemplarily illustrating a sealing member according to a third exemplary embodiment of the present invention.

It may be understood that the appended drawings are not necessarily to scale, presenting a somewhat simplified representation of various features illustrative of the basic principles of the invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Exemplary embodiments of the present application will be described more fully hereinafter with reference to the accompanying drawings, in which exemplary embodiments of the present invention are shown. As those skilled in the art would realize, the described embodiments may be modified in various different ways, all without departing from the spirit or scope of the present invention.

To clarify the present invention, portions that are not connected with the description will be omitted, and the same elements or equivalents are referred to by the same reference numerals throughout the specification.

The size and thickness of each element are arbitrarily shown in the drawings, but the present invention is not necessarily limited thereto, and in the drawings, the thickness of layers, films, panels, regions, etc., are exaggerated for clarity.

Throughout this specification and the claims which follow, unless explicitly described to the contrary, the word “comprise” or variations such as “comprises” or “comprising” will be understood to imply the inclusion of stated elements but not the exclusion of any other elements.

Furthermore, the terms, “ . . . unit”, “ . . . mechanism”, “ . . . portion”, “ . . . member”, etc. used herein mean a unit of inclusive components performing at least one or more functions or operations.

Hereinafter, a multifunctional expansion valve according to various exemplary embodiments of the present invention will be described in detail with reference to accompanying drawings.

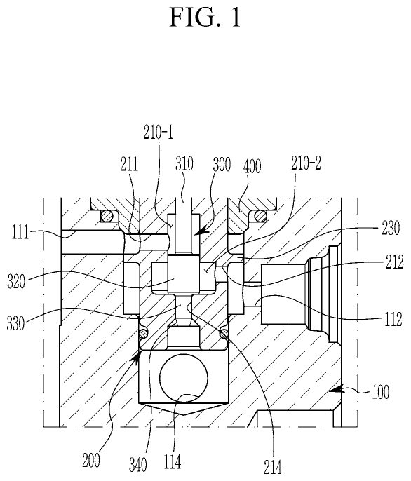

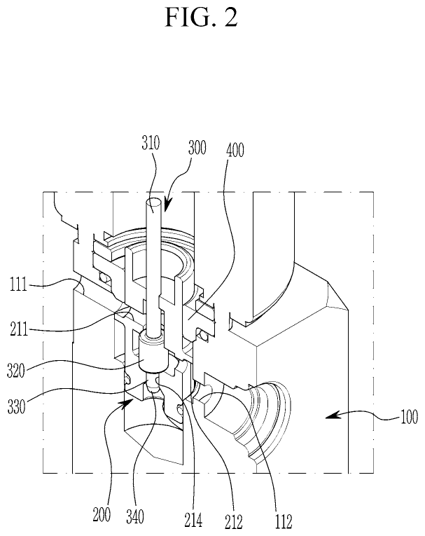

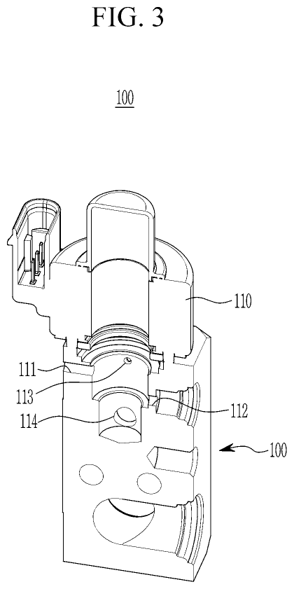

FIG. 1 is a cross-sectional view exemplarily illustrating a multifunctional expansion valve according to a first exemplary embodiment of the present invention. FIG. 2 is a partially cut-away perspective view exemplarily illustrating a valve body according to the first exemplary embodiment of the present invention. and FIG. 3 is a partially cut-away perspective view exemplarily illustrating a main housing according to the first exemplary embodiment of the present invention.

As shown in FIG. 1 and FIG. 2, a multifunctional expansion valve according to the first exemplary embodiment of the present invention may include a main housing 100, a valve body 200 provided in the main housing 100, and a needle valve 300 movably disposed in the valve body 200 along up and down directions.

The valve body 200 is provided in the main housing 100, and the valve body 200 and the main housing 100 are spaced apart with a predetermined distance thereby forming a space therebetween.

Furthermore, since a sealing member 400 is provided in the space formed between the valve body 200 and the main housing 100, it is possible to prevent from leaking fluid (e.g., coolant/refrigerant) flowing through the main housing 100.

As shown in FIG. 3, an actuator 110 is provided in the main housing 100. The actuator 110 provided in the main housing 100 supplies power for moving the needle valve 300. For this, the actuator 110 may be realized through a step motor or solenoid.

Hereinafter, the valve body 200 and the needle valve 300 will be described in detail. First, the valve body 200 will be described in detail with reference to accompanying drawings.

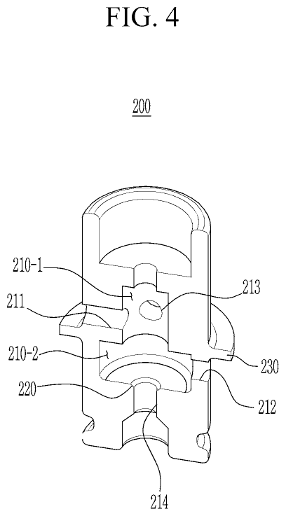

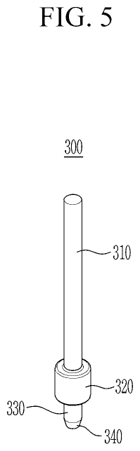

FIG. 4 is a partially cut-away perspective view exemplarily illustrating a valve body according to a first exemplary embodiment of the present invention. FIG. 5 is a perspective view exemplarily illustrating a needle valve according to a first exemplary embodiment of the present invention.

As shown in FIG. 4 and FIG. 5, the valve body 200 according to a first exemplary embodiment of the present invention is formed as a cylinder shape, formed with a chamber 210 for moving the needle valve 300 therein, and formed with a first entry 211, a second entry 212, a first exit 213, and a second exit 214.

The chamber 210 may include a first chamber 210-1, and a second chamber 210-2 formed below the first chamber 210-1. A diameter of the second chamber 210-2 may be greater than a diameter of the first chamber 210-1.

The first chamber 210-1 may be formed as a cylinder shape, and fluidically-communicating with the first entry 211 and the first exit 213. The second chamber 210-2 may be disposed below the first chamber 210-1, formed as a cylinder shape, and fluidically-communicating with the second entry 212 and the second exit 214.

The first entry 211 may be formed in an upper side surface of the valve body 200, and first exit 213 may be formed in an upper side surface of the valve body 200 at the same height with the first entry 211. That is, the first exit 213 may be disposed apart from the first entry 211 by a predetermined angle in a circumferential direction of the valve body 200.

The first entry 211 and the second entry 212 are fluidically-communicating with each other through the chamber 210, and the first entry 211 and the second entry 212 may be selectively fluidically-communicated according to a position of the needle valve 300.

Since the fluid flowing into the first entry 211 and exhausting to the first exit 213, the multifunctional expansion valve functions as a bypass valve.

The second entry 212 may be formed in a lower side surface of the valve body 200. That is, the second entry 212 is positioned below the first entry 211.

The second exit 214 may be formed in lower center portion of the valve body 200. The path of the fluid inflowing from the first entry 211 and exhausted through the second exit 214 functions as an expansion valve of an air conditioner.

For this, a valve inclined portion 220 may be formed at an upper portion of the second exit 214 or a boundary between the second chamber 210-2 and the second exit 214. The valve inclined portion 220 may have a shape such as a chamfer cut off the end portion of the second exit 214.

Meanwhile, when phases of a fluid inflowing into the first entry 211 and a fluid inflowing into the second entry 212 are different with each other, it is necessary to prevent the fluid inflowing into the first entry 211 and the fluid inflowing into the second entry 212 from mixing with each other.

To the present end, a separation wall 230 is formed to extend toward an internal wall of the main housing 100 from an external circumference of the valve body 200. The separation wall 230 may be formed to extend toward the main housing 100 from the external circumference of the valve body between the first entry 211 and the second entry 212.

Accordingly, the needle valve 300 according the exemplary embodiment of this will be described in detail with reference to accompanying drawings.

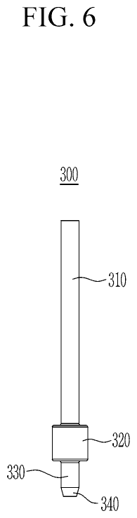

FIG. 5 is a perspective view exemplarily illustrating a needle valve according to a first exemplary embodiment of the present invention. FIG. 6 is a side view exemplarily illustrating a needle valve according to a first exemplary embodiment of the present invention.

As shown in FIG. 5 and FIG. 6, the needle valve 300 according to the first exemplary embodiment of the present invention may be formed as a cylinder shape, and include a needle body 310, a needle enlargement portion 320, and a needle expansion portion 330.

The needle body 310, the needle enlargement portion 320, and the needle expansion portion 330 are sequentially formed in a longitudinal direction of the needle valve 300.

A diameter of the needle enlargement portion 320 formed as a cylinder shape may correspond to a diameter of the first chamber 210-1, and a diameter of the needle expansion portion 330 may correspond to a diameter of the second exit 214 of the valve body 200.

At the present time, the diameter of needle enlargement portion 320 may greater than the diameter of the needle body 310, and the diameter of needle expansion portion 330 may less than the diameter of the needle enlargement portion 320. and the diameter of needle enlargement portion 320 of the needle valve 300 may be less than the diameter of the second chamber 210-2 of the valve body 200.

Accordingly, when the needle enlargement portion 320 of the needle valve 300 is positioned in the first chamber 210-1 of the valve body 200, the first entry 211 and the first exit 213 are blocked, and the second entry 212 and the second exit 214 communicate with each other through the second chamber 210-2.

When the needle expansion portion 330 of the needle valve 300 is position in the second exit 214 of the valve body 200, the second entry 212 and the second exit 214 are blocked, and the first entry 211 and the first exit 213 communicate with each other through the first chamber 210-1.

A needle inclined portion 340 is formed in an end portion of the needle expansion portion 330. The needle inclined portion 340 may be formed in a shape such as a chamfer cut off the lower end portion of the needle expansion portion 330. The needle inclined portion 340 of the needle valve 300 and the valve inclined portion 220 of the valve body 200 cooperate to function as an expansion valve. That is, as the fluid passes through the narrow gap between the needle inclined portion 340 and the valve inclined portion 220, the fluid expands.

In various exemplary embodiments of the present invention, the needle valve 300 moves to a predetermined position in the up and down directions by the power of the driving unit 110. To the present end, the actuator may be implemented through a step motor or a solenoid.

Referring to FIG. 3, a first inlet conduit 111, a second inlet conduit 112, a first outlet conduit 113, and a second outlet conduit 114 are formed in the main housing 100.

The first inlet conduit 111 communicates with the first entry 211 of the valve body 200, the second inlet conduit 112 communicates with the second entry 212 of the valve body 200, the first outlet conduit 113 communicates with the first exit 213 of the valve body 200, and the second outlet conduit 114 communicates with the second exit 214 of the valve body 200.

The first inlet conduit 111 and the first outlet conduit 113 are connected to a bypass line of a heat pump system such that the fluid inflowing into the first inlet conduit 111 is selectively discharged to the first outlet conduit 113 through the valve body 200.

The second inlet conduit 112 is connected to a condenser and the second outlet conduit 114 is connected to an evaporator such that the fluid inflowing into the second inlet conduit 112 is selectively discharged to the second outlet conduit 114 through the valve body 200.

Hereinafter, an operation of the multifunctional expansion valve according to the first exemplary embodiment of the present invention will be described in detail with reference to accompanying drawings.

In various exemplary embodiments of the present invention, the needle valve 300 may be operated in three modes (first mode to third mode) moving in the up and down directions. The needle valve 300 may be operated in any one of the three modes by power of the actuator.

In various exemplary embodiments of the present invention, the first mode to third mode may mean a position of the needle valve 300, and the needle valve 300 may be positioned in the second mode and the third mode as the needle valve 300 moves to a predetermined position based on the first mode.

The first mode may mean a mode in which the needle valve 300 is position at a lowest position inside the chamber 210 of the valve body 200. The second mode may mean a mode in which the needle valve 300 is positioned upward by a predetermined height from the first mode. and the third mode may mean a mode in which the needle valve 300 is positioned upward by a predetermined height from the second mode.

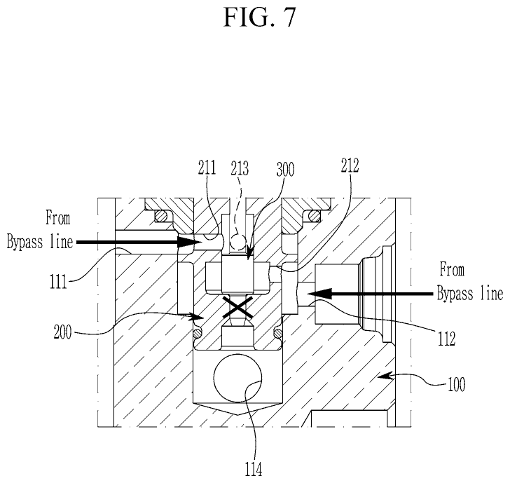

FIG. 7 is a drawing for explaining an operation of a multifunctional expansion valve in a first mode according to a first exemplary embodiment of the present invention.

Referring to FIG. 7, in the first mode, the needle valve 300 moves to a lowest position inside the chamber of the valve body 200, and the needle expansion portion 330 of the needle valve 300 is fully inserted into the second chamber 210-2 of the valve body 200.

Accordingly, the first entry 211 fluidically-communicating with the second exit 214 through the first chamber 210-1, and the second entry 212 and the second exit 214 are blocked.

Therefore, the fluid inflowing into the first inlet conduit 111 of the main housing 100 is discharged to the first outlet conduit 113 of the main housing 100 passing through the first entry 211, the first chamber 210-1, and the first exit 213 of the valve body 200.

And the fluid flowing through the second inlet conduit 112 of the main housing 100 is blocked without inflowing into the valve body 200.

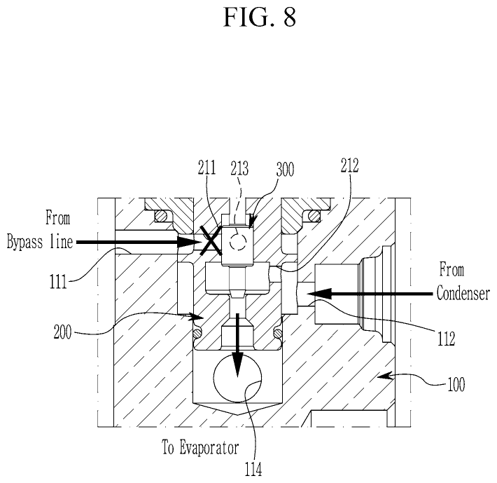

FIG. 8 is a drawing for explaining an operation of a multifunctional expansion valve in a second mode according to a first exemplary embodiment of the present invention.

Referring to FIG. 8, in the second mode, the needle valve 300 moves upward by a predetermined height from the lowest position of the chamber of the valve body 200, the needle enlargement portion 320 of the needle valve 300 is fully inserted into the first chamber 210-1 of the valve body 200, and the needle inclined portion 340 of the needle valve 300 and the valve inclined portion 220 of the valve body 200 are positioned to face each other.

Accordingly, the first entry 211 and the first exit 213 are blocked by the needle enlargement portion 320, and the second entry 212 and the second exit 214 communicate with each other through the second chamber 210-2.

Therefore, the fluid flowing through the first inlet conduit 111 of the main housing 100 is blocked without inflowing into the valve body 220 since the needle enlargement portion 320 is blocking the first chamber 210-1 of the valve body 200.

And the fluid flowing into through the second inlet conduit 112 of the main housing 100 is discharged to the second outlet conduit 114 passing through the second entry 212, the second chamber 210-2, and the second exit 214 of the valve body 200.

At the present time, the pressure of the fluid is dropped and the volume of the fluid is expanded as the fluid flowing from the second entry 212 to the second exit 214 passes through the narrow gap between the needle inclined portion 340 of the needle valve 300 and the valve inclined portion 220 of the valve body 200. That is, when the fluid inflowing from the second entry 212 is discharged to the second exit 214, it functions as an expansion valve that expands the volume of the fluid.

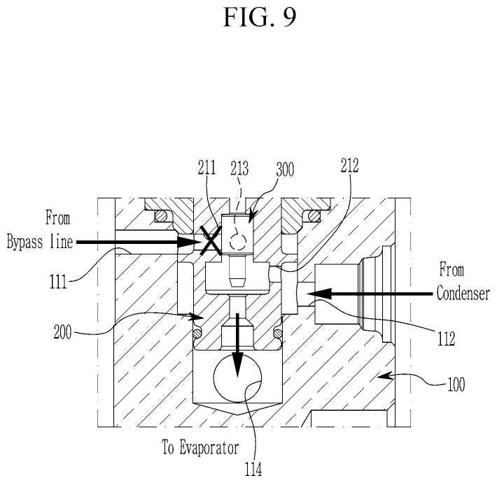

FIG. 9 is a drawing for explaining an operation of a multifunctional expansion valve in a third mode according to a first exemplary embodiment of the present invention.

Referring to FIG. 9, in third mode, the needle valve 300 moves to a highest position inside the chamber of the valve body 200, the needle enlargement portion 320 is fully inserted into the first chamber 210-1 of the valve body 200, and the needle expansion portion 330 is fully separated from the second exit 214 of the valve body 200.

Accordingly, the first entry 211 and the first exit 213 are blocked by the needle enlargement portion 320 of the needle valve 300, and the second entry 212 and the second exit 214 communicate with each other through the second chamber 210-2.

Therefore, since the needle enlargement portion 320 is blocking the first chamber 210-1 of the valve body 200, the fluid flowing through the first inlet conduit 111 of the main housing 100 is blocked without flowing into the valve body 200.

And the fluid flowing through the second inlet conduit 112 of the main housing 100 is discharged to the second outlet conduit 114 passing through the second entry 212, the second chamber 210-2, and the second exit 214 of the valve body 200.

At the present time, since the needle expansion portion 330 of the needle valve 300 is fully separated from the second exit 214, the fluid flowing from second entry 212 is expelled to the second exit 214 through the second chamber 210-2 without fluid expansion.

Hereinafter, a multifunctional expansion valve according to a second exemplary embodiment and a third exemplary embodiment of the present invention will be described in detail with reference to accompanying drawings.

The basic structure of the multifunctional expansion valve according to the second exemplary embodiment and the third exemplary embodiment of the present invention is similar to that of the multifunctional expansion valve according to the first exemplary embodiment of the present invention described above. However, there is only difference of the structure that prevents the fluid inflowing to the first entry 211 and the fluid inflowing to the second entry 212 from being mixed with each other. Therefore, in the description of the second exemplary embodiment and the third exemplary embodiment of the present invention, only portions that are different from the first exemplary embodiment will be described.

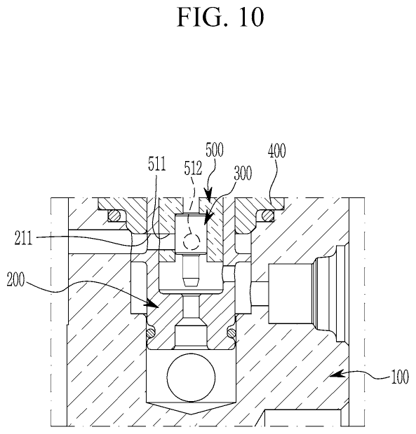

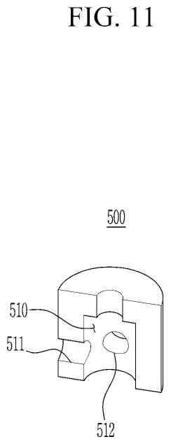

FIG. 10 is a cross-sectional view exemplarily illustrating a multifunctional expansion valve according to a second exemplary embodiment of the present invention. and FIG. 11 is a partially cut-away perspective view exemplarily illustrating an auxiliary body according to a second exemplary embodiment of the present invention.

As shown in FIG. 10 and FIG. 11, in the multifunctional expansion valve according to the second exemplary embodiment of the present invention, the valve body 200 includes an auxiliary body 500.

The auxiliary body 500 is provided in the chamber 210 formed in the valve body 200, and formed with a first connection conduit 511 connected to the first entry 211, a second connection conduit 512 connected to the first exit 213, and an auxiliary chamber 510 communicating with the first connection conduit 511 and the second connection conduit 512.

In the second exemplary embodiment of the present invention, the auxiliary chamber 510 of the auxiliary body 500 corresponds to the first chamber 210-1 of the valve body 200 in the first exemplary embodiment of the present invention. Accordingly, the configurations corresponding to the first chamber 210-1 of the valve body 200 in the first exemplary embodiment same function as the configurations corresponding to the auxiliary chamber 510 of the auxiliary body 500 in the second exemplary embodiment of the present invention.

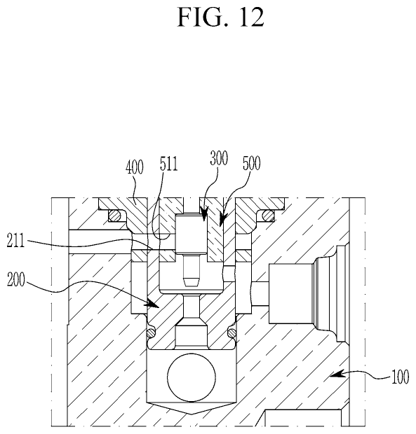

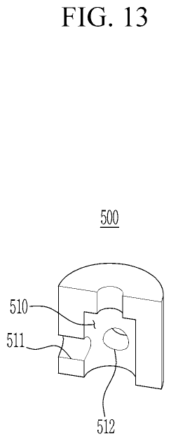

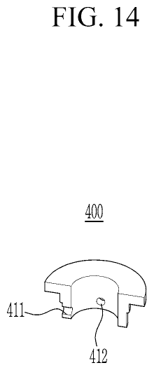

FIG. 12 is a cross-sectional view exemplarily illustrating a multifunctional expansion valve according to a third exemplary embodiment of the present invention. FIG. 13 is a partially cut-away perspective view exemplarily illustrating an auxiliary body according to a third exemplary embodiment of the present invention. FIG. 14 is a partially cut-away perspective view exemplarily illustrating a sealing member according to a third exemplary embodiment of the present invention.

As shown in FIG. 12, FIG. 13, and FIG. 14, in a multifunctional expansion valve according to a third exemplary embodiment of the present invention, the valve body 200 includes an auxiliary body 500.

The auxiliary body 500 is provided in the chamber 210 formed in the valve body 200, and formed with a first connection conduit 511 connected to the first entry 211, a second connection conduit 512 connected to the first exit 213, and an auxiliary chamber 510 communicating with the first connection conduit 511 and the second connection conduit 512.

In third exemplary embodiment of the present invention, the auxiliary chamber 510 of the auxiliary body 500 corresponds to the of the valve body 200 in the first exemplary embodiment of the present invention.

Accordingly, the configurations corresponding to the first chamber 210-1 of the valve body 200 in the first exemplary embodiment same function as the configurations corresponding to the auxiliary chamber 510 of the auxiliary body 500 in the third exemplary embodiment of the present invention.

Furthermore, a sealing member 400 provided between the valve body 200 and the main housing 100 is formed with a first connection passage 411 connecting the first inlet conduit 111 of the main housing 100 and the first entry 211 of the valve body 200, and a second connection passage 412 connecting the first outlet conduit 113 of the main housing 100 and the first exit 213 of the valve body 200.

Since the first connection passage 411 and the second connection passage 412 are formed in the sealing member 400, it is possible to preventing the fluid inflowing into the first entry 211 through the first inlet conduit 111 and the fluid inflowing into the second entry 212 through the second inlet conduit 112 from being mixed.

As described above, by performing the functions as a bypass valve and an expansion valve through one valve (multifunctional expansion valve), the overall structure of the heat pump system may be simplified and the manufacturing cost of the vehicle may be reduced.

Furthermore, since the flow of the fluid inside the valve body 200 is controlled as the needle valve 300 moves to a predetermined position in the up and down directions, the valve may be easily controlled.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A multifunctional expansion valve apparatus comprising:
a valve body including a first entry, a second entry, a first exit, a second exit, and a chamber fluidically-communicating with the first entry, the second entry, the first exit, and the second exit; and
a needle valve movably mounted in the chamber of the valve body along a longitudinal direction of the chamber;
wherein the first entry and the first exit are selectively fluidically-communicated to each other and the second entry and the second exit are selectively fluidically-communicated to each other according to a position of the needle valve.

2. The multifunctional expansion valve apparatus of claim 1, wherein the chamber includes:
a first chamber connected to the first entry and the first exit, and
a second chamber connected to the second entry, disposed below the first chamber, and having a diameter larger than a diameter of the first chamber;
wherein the valve body includes a valve inclined portion formed in a boundary between the second chamber and the second exit.

3. The multifunctional expansion valve apparatus of claim 2, wherein the needle valve includes:
a needle body;
a needle enlargement portion corresponding to the dimeter of the first chamber;
a needle expansion portion formed below the needle enlargement portion and corresponding to a dimeter of the second exit; and
a needle inclined portion formed in an end portion of the needle expansion portion.

4. The multifunctional expansion valve apparatus of claim 3,
wherein the position of the needle valve includes a first position, a second position and a third position,
wherein the first entry and the first exit fluidically-communicate with each other, and the second entry and the second exit are blocked in the first mode where the needle valve moves toward the first position,
wherein the first entry and the first exit are blocked, and the second entry and the second exit partially communicate with each other in the second mode where the needle valve moves toward the second position, and
wherein the first entry and the first exit are blocked, and the second entry and the second exit fluidically-communicate with each other in the third mode where the needle valve moves toward the third position.

5. The multifunctional expansion valve apparatus of claim 4, wherein in the first mode,
the needle valve is configured to move toward a lowest position inside the chamber,
the needle expansion portion of the needle valve is fully inserted into the second exit, blocking the second entry and the second exit, and
the first entry and the second exit fluidically-communicate with each other through the first chamber.

6. The multifunctional expansion valve apparatus of claim 4, wherein in the second mode,
the needle valve is configured to move upward by a predetermined height from a lowest position inside the chamber,
the needle enlargement portion of the needle valve is fully inserted into the first chamber so that the first entry and the first exit are blocked, and
the needle expansion portion of the needle valve is partially inserted into the third chamber so that the second entry and the second exit partially communicate with each other.

7. The multifunctional expansion valve apparatus of claim 6,
wherein the needle inclined portion and the valve inclined portion are disposed to face each other,
wherein fluid flowing through the second entry is expanded through a gap between the needle inclined portion of the needle valve and the valve inclined portion of the valve body.

8. The multifunctional expansion valve apparatus of claim 4, wherein in the third mode,
the needle valve is configured to move toward a highest position inside the chamber,
the needle enlargement portion of the needle valve is fully inserted into the first chamber so that the first entry and the first exit are blocked, and
the needle expansion portion of the needle valve is fully separated from the third chamber so that the second entry and the second exit fully communicate with each other.

9. The multifunctional expansion valve apparatus of claim 1, further including:
a main housing into which the valve body is slidably accommodated, and formed with a first inlet conduit fluidically-communicating with the first entry, a second inlet conduit fluidically-communicating with the second entry, a first outlet conduit fluidically-communicating with the first exit, and a second outlet conduit fluidically-communicating with the second exit; and
a sealing member mounted between the main housing and the valve body.

10. The multifunctional expansion valve apparatus of claim 9, further including:
a separation wall extending toward an internal wall of the main housing from an external circumference of the valve body between the first entry and the second entry to separate a fluid flowing from the first entry and a fluid flowing from the second entry between the valve body and the main housing.

11. A multifunctional expansion valve apparatus comprising:
a valve body including a first entry, a second entry, a first exit, a second exit, and a chamber fluidically-communicating with the first entry, the second entry, the first exit, and the second exit; and
an auxiliary body provided in the chamber, and including a first connection conduit connected to the first entry, a second connection conduit connected to the first exit, and an auxiliary chamber fluidically-communicating with the first connection conduit and the second connection conduit; and
a needle valve movably disposed in the chamber of the valve body in a longitudinal direction of the chamber;
wherein the first entry and the first exit are selectively fluidically-communicated to each other and the second entry and the second exit are selectively fluidically-communicated to each other according to a position of the needle valve.

12. The multifunctional expansion valve apparatus of claim 11, wherein the chamber includes:
a first chamber provided with the auxiliary body; and
a second chamber connected to the second entry and disposed below the first chamber;
wherein the valve body includes a valve inclined portion formed in a boundary between the second chamber and the second exit.

13. The multifunctional expansion valve apparatus of claim 12, wherein the needle valve includes:
a needle body;
a needle enlargement portion corresponding to an internal diameter of the auxiliary chamber;
a needle expansion portion formed below the needle enlargement portion and corresponding to a diameter of the third chamber; and
a needle inclined portion formed in an end portion of the needle expansion portion.

14. The multifunctional expansion valve apparatus of claim 13,
wherein the position of the needle valve includes a first position, a second position and a third position,
wherein the first entry and the first exit fluidically-communicate with each other, and the second entry and the second exit are blocked in a first mode where the needle valve moves toward the first position,
wherein the first entry and the first exit are blocked, and the second entry and the second exit partially communicate with each other in a second mode where the needle valve moves toward the second position, and
wherein the first entry and the first exit are blocked, and the second entry and the second exit fully communicate with each other in a third mode where the needle valve moves toward the third position.

15. The multifunctional expansion valve apparatus of claim 14, wherein in the first mode,
the needle valve is configured to move toward a lowest position inside the chamber,
the needle expansion portion of the needle valve is fully inserted into the second exit, blocking the second entry and the second exit, and
the first entry and the second exit fluidically-communicate with each other through the first chamber.

16. The multifunctional expansion valve apparatus of claim 14, wherein in the second mode,
the needle valve is configured to move upward by a predetermined height from a lowest position inside the chamber,
the needle enlargement portion of the needle valve is fully inserted into the first chamber so that the first entry and the first exit are blocked, and
the needle expansion portion of the needle valve is partially inserted into the third chamber so that the second entry and the second exit partially communicate with each other.

17. The multifunctional expansion valve apparatus of claim 16,
wherein the needle inclined portion and the valve inclined portion are disposed to face each other, and
wherein fluid flowing through the second entry is expanded through a gap between the needle inclined portion of the needle valve and the valve inclined portion of the valve body.

18. The multifunctional expansion valve apparatus of claim 14, wherein in the third mode,
the needle valve is configured to move toward a highest position inside the chamber,
the needle expansion portion of the needle valve is fully inserted into the first chamber so that the first entry and the first exit are blocked, and
the needle expansion portion of the needle valve is fully separated from the third chamber so that the second entry and the second exit fully communicate with each other.

19. The multifunctional expansion valve apparatus of claim 11, further including:
a main housing into which the valve body is accommodated, wherein the main housing includes a first inlet conduit fluidically-communicating with the first entry, a second inlet conduit fluidically-communicating with the second entry, a first outlet conduit fluidically-communicating with the first exit, and a second outlet conduit fluidically-communicating with the second exit; and
a sealing member mounted between the main housing and the valve body.

20. The multifunctional expansion valve apparatus of claim 19, further including:
a separation wall extending toward an internal wall of the main housing from an external circumference of the valve body between the first entry and the second entry to separate a fluid flowing from the first entry and a fluid flowing from the second entry between the valve body and the main housing.
